(19) United States
(12) Patent Application Publication
(10) Pub. No.: US 2003/0102859 A1
(43) Pub. Date: Jun. 5, 2003

(54) Two-wire direct current electric fan system with countable rotation rate

(76) Inventor: Ching-Chuan Wae, Taipei (TW)

Correspondence Address: BIRCH STEWART KOLASCH & BIRCH, PO BOX 747, FALLS CHURCH, VA, 22040-0747, US

(21) Appl. No.: 10/000,398

(22) Filed: Dec. 4, 2001

(51) Int. Cl. G01P 3/48

(52) U.S. Cl. 324/174; 324/207.2

(57) ABSTRACT

A kind of two-wire direct current electric fan system with countable rotation rate, which is used in the systemic radiating electric fan of an information processing device. It contains a two-wire direct current electric fan, a rotation rate inducing circuit, a pulse amplifying circuit and a counting circuit. The system of the invention utilizes the rotation rate inducing circuit of the two-wire direct current electric fan, which is installed on the motherboard of the information processing device. It converts the rotation of the electric fan into a pulse, and amplifies the pulse to a detectable level. The rotation rate of the electric fan is then determined by the counting circuit on the motherboard. The invention uses a two-wire electric fan to achieve the objective of rotation rate counting.

### BACKGROUND OF THE INVENTION

1. Field of the Invention

The invention relates to a kind of two-wire direct current electric fan system with countable rotation rate, which is used with a systemic radiating electric fan of information processing equipment.

2. Related Art

The systemic electric fan of information processing equipment in the past, i.e., the radiating electric fan, had only a simple two-wire design, i.e., a power cord and a ground wire. However, in order to allow the motherboard to monitor the rotation state, the current computer systemic electric fan adds one more rotation rate counting wire, which is used to count the rotation rate of the fan. In other words, it has become a three-wire electric fan. This kind of design can achieve the rotation rate counting function by producing a pulse signal. The counting result of the rotation rate counting wire is sent to the CMOS (Complement Metal Oxide Semiconductor) of the system motherboard, and the computer can monitor the rotation state by the CMOS. If the electric fan does not work smoothly, it can be replaced immediately. Thus, it can prevent the CPU from over-heating and crashing, which is caused by the electric fan stopping or functioning abnormally.

The electric fan that includes the rotation rate counting wire, generally speaking, is a three-wire direct current fan system. Some electric fan manufacturers have even designed four-wire type electric fan systems. No matter how many wires there are in an electric fan, the main function of the electric fan is to radiate the heat of the central processing unit. The design objective of the rotation rate counting wire is to count the rotation rate of the electric fan for monitoring.

The concrete three-wire direct current electric fan is shown in FIG. 1. The three-wire direct current electric fan 10 includes a Hall sensor 20, power cord 30, ground wire 40, rotation rate counting wire 50, and connector 60. The Hall sensor is responsible for inducing the rotation rate of the electric fan. The electric fan outputs a pulse by the rotation rate counting wire 50 when it completes one revolution. The information processing equipment can count the rotation rate of the electric fan by the pulse.

FIG. 2 is a block diagram of the prior art three-wire direct current electric fan system. The circuit of the three-wire direct current electric fan 10 contains a rotation rate inducing circuit 70 and a pulse amplifying circuit 80. A counting circuit 90 is placed on the motherboard. The rotation rate induced circuit 70 induces the rotation of the electric fan blade, and it sends out a pulse when the electric fan completes one revolution. The pulse is amplified by the pulse amplifying circuit 80, and is passed to the counting circuit 90 on the motherboard of the information processing device by the rotation rate counting wire 50. Thus, the rotation rate of the three-wire direct current electric fan 10 can be determined.

FIG. 3 is the prior art three-wire electric fan circuit. The three-wire direct current electric fan 10 includes the rotation rate inducing circuit 70 and the pulse amplifying circuit 80. The rotation rate inducing circuit 70 comprises several components: the Hall sensor 20, first resistor 100, first inductor 110, first transistor 120, second resistor 130, second inductor 140 and second transistor 150. These are the basic components for producing the Hall inducing pulse. The pulse amplifying circuit 80 is made up of an amplifier 160.

As shown in FIG. 3, when the three-wire direct current electric fan 10 rotates, the Hall sensor 20 can induce magnetic field change due to the blade rotating, and send a micro pulse signal from the first point 101. This micro pulse signal is amplified to a detectable voltage after passing through the amplifier 160, and it is output from the second point 102. It is sent to the counting circuit 90 on the motherboard of the information processing device by the rotation rate counting wire 50. This amplified pulse can be used to calculate the rotation rate of the electric fan.

Although this design allows users to monitor the rotation state of the systemic electric fan, it also causes some problems. For example, the electric fan designers have to design amplifying circuits for counting the rotations of the electric fan. This causes complications for the electric fan, as with the design for the amplifier 160 shown in FIG. 3.

Moreover, designers must consider the arrangement of the added circuit for the counting function. One design involved the power cord end and the rotation rate counting end of the connector 60 being connected to both ends of the three junctions, with the ground wire in the middle. In order to avoid inserting error at each end, some sort of error protection for improper insertion must be designed. Even if the system has such error protection, some users still incorrectly insert the plugs of the three-connector-end by inserting the power cord end in the jack for the rotation rate counting end, or vice versa. Therefore, the rotation rate counting end receives higher voltage than the power cord end, which causes the motherboard or some important chips to burn out.

### SUMMARY OF THE INVENTION

Aiming at the prior technical problems mentioned above, the invention provides a kind of two-wire direct current electric fan system with countable rotation rate. Only one power cord and one ground wire are needed to achieve the rotation rate counting function of the electric fan.

The two-wire direct current electric fan system with countable rotation rate of the invention is used in the systemic radiation of information processing devices. It includes a two-wire direct current electric fan, a rotation rate inducing circuit, a pulse amplifying circuit, and a counting circuit. The two-wire direct current electric fan is installed on the motherboard of the information processing device, and shares one power cord and one ground wire. The power cord acts as the power supplying wire and rotation rate inspecting wire of the two-wire direct current electric fan. The rotation inducing circuit is installed on the electric fan, and is used to output a pulse by the power cord when the electric fan completes one revolution. The pulse amplifying circuit is installed on the motherboard, with its input end connecting to the power cord of the electric fan. It is used to receive the pulse output from the power cord, and amplify and send the pulse to the output end of the pulse amplifying circuit. The counting circuit is installed on the motherboard, with its input end connecting to the output end of the pulse amplifying circuit. It is used to calculate the rotation rate of the electric fan.

Further scope of applicability of the invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

FIG. 1 is a diagram of the prior art three-wire electric fan;

FIG. 2 is a block diagram of the prior art three-wire electric fan;

FIG. 3 is a circuit diagram of the prior art three-wire electric fan;

FIG. 4 is a diagram of the two-wire electric fan system with countable rotation rate of the invention;

FIG. 5 is a block diagram of the two-wire electric fan system with countable rotation rate of the invention; and

FIG. 6 is a circuit diagram of the two-wire electric fan system with countable rotation rate of the invention.

### DETAILED DESCRIPTION OF THE INVENTION

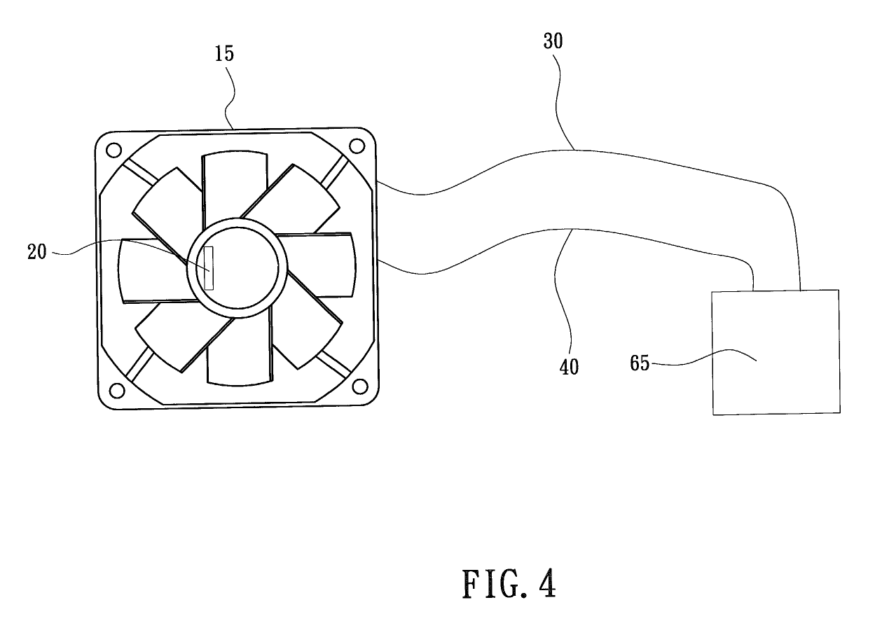

The two-wire direct current electric fan system with countable rotation rate of the invention is shown in FIG. 4, which is a diagram of the two-wire direct current electric fan system. The two-wire direct current electric fan 15 includes the Hall sensor 20, power cord 30, ground wire 40 and connector 65. The Hall sensor can induce the magnetic field change of the electric fan blade, and convert it into pulse output.

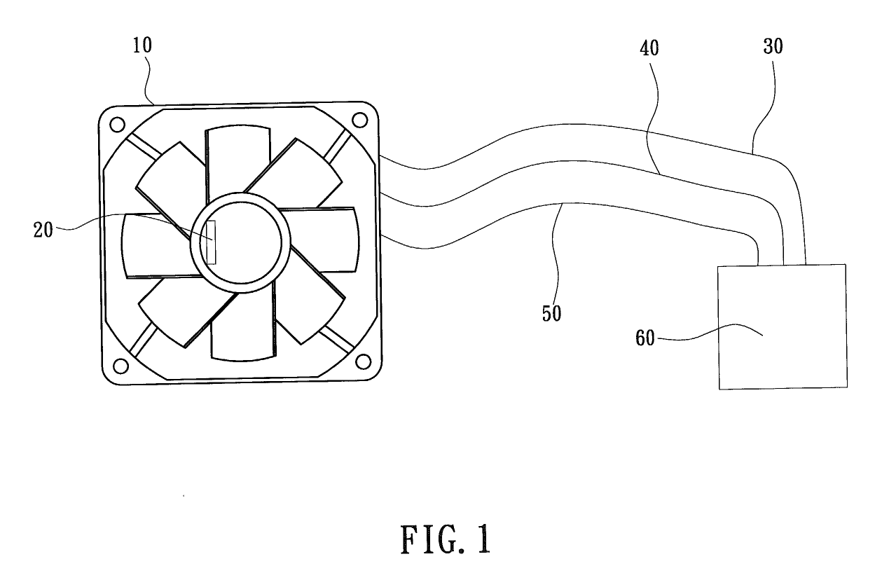

The two-wire direct current electric fan 15 of the invention is very different from the three-wire direct current electric fan 10 in FIG. 1. The two-wire direct current electric fan of the invention has only two circumscribed wires, the power cord 30 and the ground wire 40. It lacks the rotation rate counting wire 50. Therefore, there are only two ends of the connector 65, which are the power cord end and ground wire end (not shown in the Figure). Although the design contains only two wires, the two-wire direct current electric fan 15 of the invention can still do the rotation rate counting work of the electric fan.

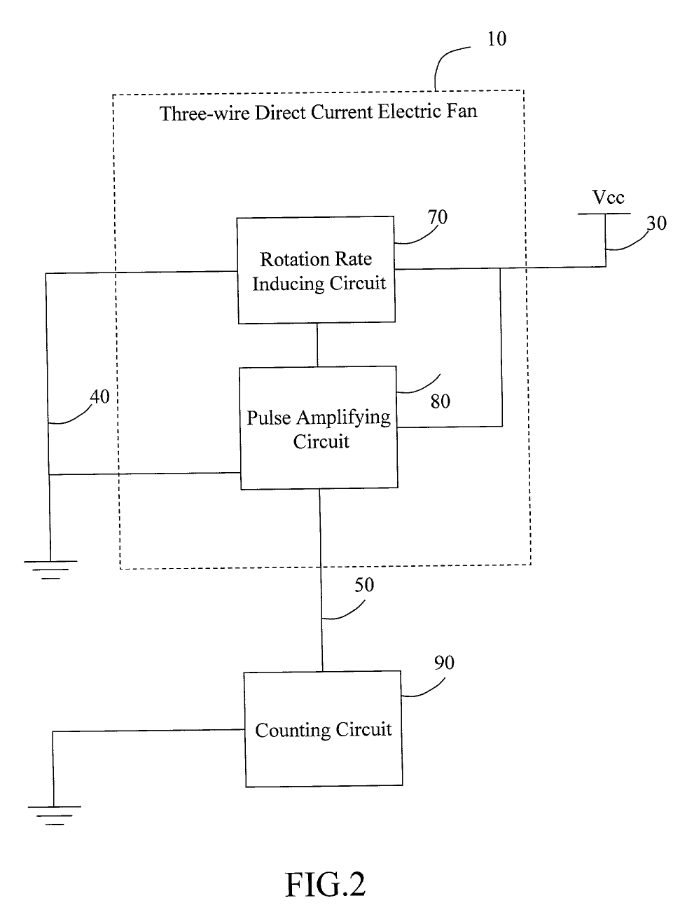

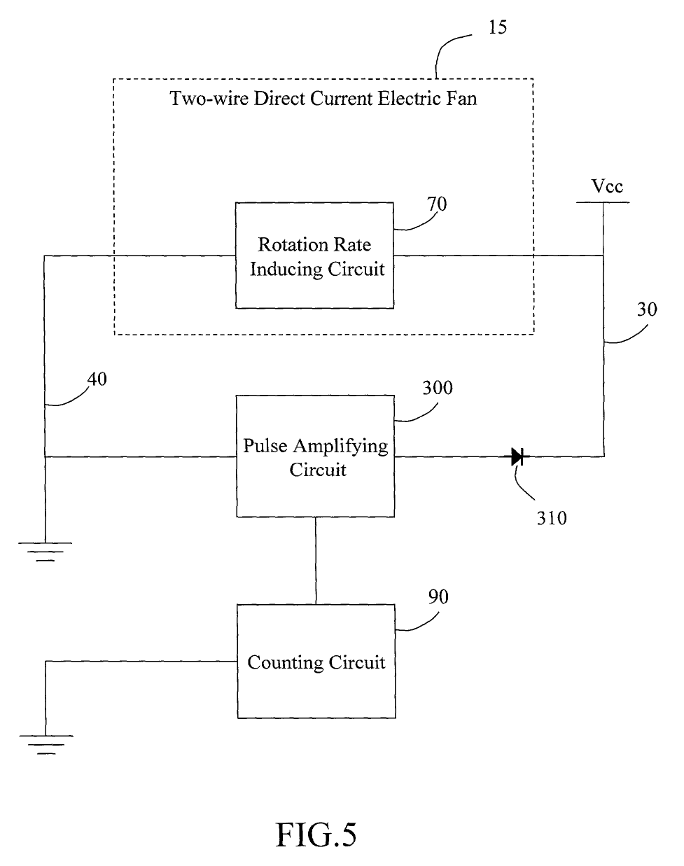

Please further refer to the FIG. 5, which is a block diagram of the two-wire direct current electric fan with countable rotation rate of the invention. Compare this with FIG. 2.

In FIG. 5, the circuit of the two-wire direct current electric fan contains the rotation rate inducing circuit 70. Compared with the three-wire direct current electric fan 10 in FIG. 2, this circuit lacks the pulse amplifying circuit 80. Thus, the design for the electric fan of the invention is simpler. In the invention, the two-wire direct current electric fan system with countable rotation rate applies the amplifying circuit 300 to the motherboard of the information processing device, so that it can amplify the pulse in a more simple way. In the two-wire design as shown in FIG. 4, the power cord 30 connects directly to the motherboard via the connector 65. Besides the pulse amplifying circuit 300, a diode 310 is installed to execute the detection. Thus, the pulse produced by the rotation rate inducing circuit 70 can be sent to the amplifying circuit 300 by the power cord 30 in order to amplify. The counting circuit 90 can use the ready-made counting circuit on the motherboard, e.g., LM87, to count.

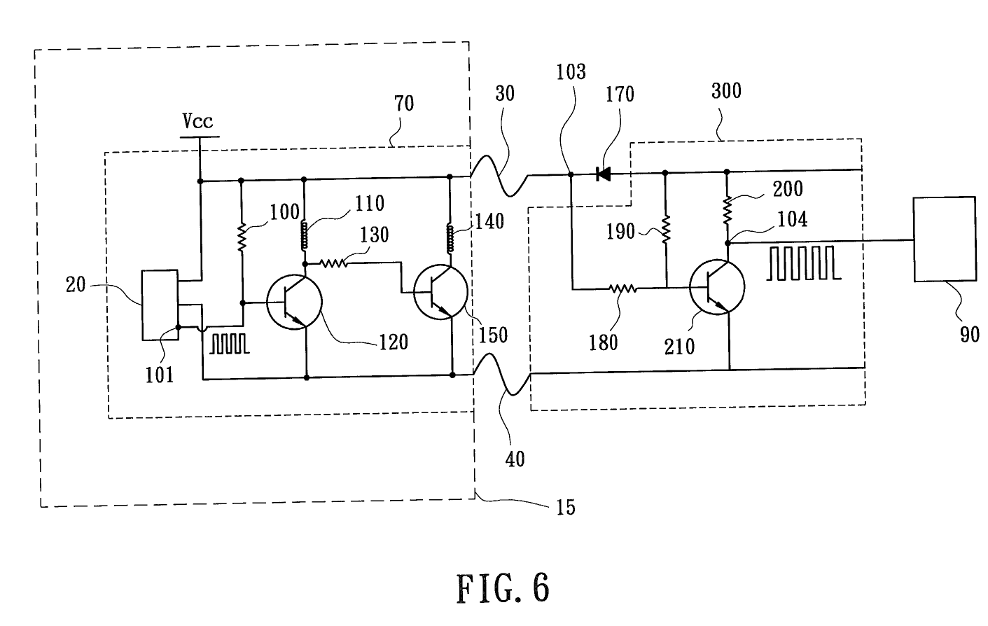

In order to explain the technique and the optimum executing example more clearly, please refer to FIG. 6, which is a circuit diagram of the two-wire electric fan system with countable rotation rate.

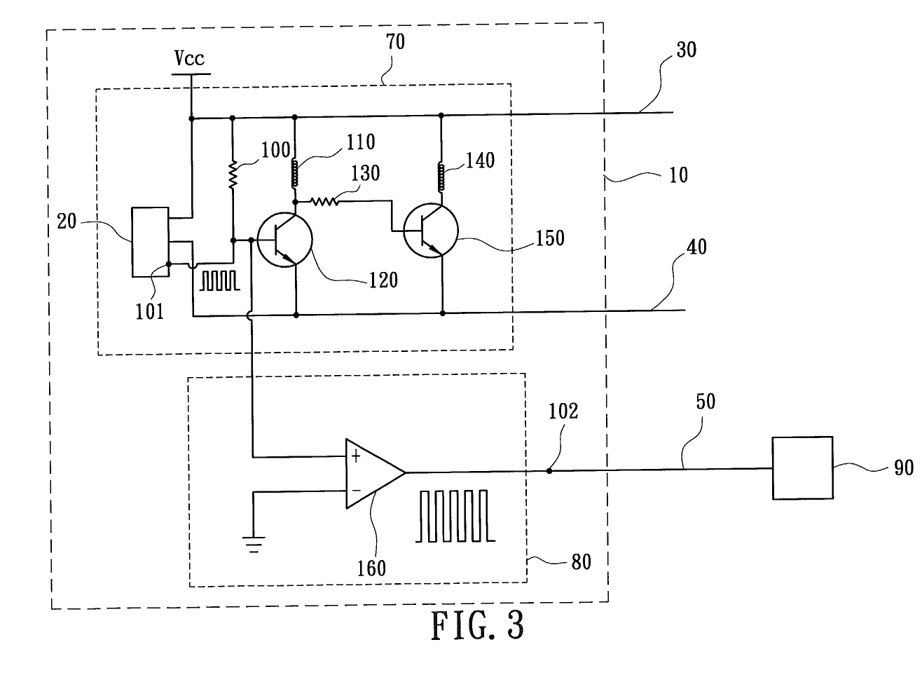

As shown in FIG. 6, the two-wire direct current electric fan 15 includes a rotation rate inducing circuit 70. This circuit contains a Hall IC, composed by a Hall sensor 20, first resistor 100, first inductor 110, first transistor 120, second resistor 130, second inductor 140, second transistor 150, etc. The two-wire direct current electric fan 15 does not contains the pulse amplifying circuit 80, which is included in the three-wire direct current electric fan 10 in FIG 3. In the invention, another pulse amplifying circuit 300 and diode 170 (which is the diode 310 in FIG. 5) are designed on the motherboard of the information processing equipment. The pulse amplifying circuit 300 contains the third resistor 180, the forth resistor 190, the fifth resistor 200, and the third transistor 210. The method of operation of the pulse amplifying circuit 300 and the diode 170 is described below:

When the two-wire direct current electric fan 15 rotates, a pulse is output from the first point 101. Each pulse indicates that the electric fan has completed one revolution. The pulse becomes a micro pulse after passing the first resistor 100. The micro pulse can be displayed on the power cord 30. Provided that the micro pulse is amplified appropriately, the necessary pulse data of the rotation rate can be produced.

In FIG. 6, since the pulse produced from the first point 101 couples with the power signal of the power cord, it is necessary to separate them. The signal sent to the first point 103 of the pulse amplifying circuit 300 from the power cord 30 can sample a micro pulse signal after the inspection of the diode 170. The micro pulse signal produces a small voltage change at the base of the third transistor 210 after passing the third resistor 180. After the amplification of the third transistor 210, the voltage change can output an amplified pulse signal at the forth point 104, between the third transistor 210 and the fifth resistor 200. This pulse signal can be used to calculate the rotation rate of the two-wire direct current electric fan by the counting circuit 90 on the motherboard.

The two-wire direct current electric fan system of the invention contains only one power cord and one ground wire. It can achieve the calculation function of the electric fan, by sending a micro pulse from the power cord of the electric fan.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A two-wire direct current electric fan system with countable rotation rate for radiating a system of an information processing equipment, comprising:
a two-wire direct current electric fan installed on a motherboard of the information processing equipment, which uses one power cord and one ground wire, wherein the power cord is used for supplying power and inspecting a rotation rate of the two-wire direct current electric fan;
a rotation rate inducing circuit installed on the two-wire direct current electric fan for outputting a pulse from a power cord after the two-wire direct current electric fan rotates one circle;
a diode installed on the motherboard, which has a negative pole connected to the power cord and is used to sample a wave pattern of the pulse;
a pulse amplifying circuit installed on the motherboard, which has a first input end of this circuit connected to the power cord of the two-wire direct current electric fan and the negative pole of the diode and a second input end connected to a positive pole of the diode and is used to receive the pulse output by the power cord, also to amplify and send the pulse to the output end of the pulse amplifying circuit; and
a counting circuit installed on the motherboard, which has an input end connected to the output end of the pulse amplifying circuit and is used to calculate a periodic number of the pulse as a rotation rate of the electric fan.

2. The two-wire direct current electric fan system with countable rotation rate of claim 1, wherein the rotation rate inducing circuit at least includes a Hall IC composed by a Hall sensor.

3. The two-wire direct current electric fan system with countable rotation rate of chaim 2, wherein the Hall sensor induces a magnetic field change of the electric fan blades and converts the magnetic field into the pulse.

4. The two-wire direct current electric fan system with countable rotation rate of claim 1, wherein the pulse amplifying circuit at least includes a transistor.

5. The two-wire direct current electric fan system with countable rotation rate of claim 4, wherein a base end of the transistor connects to the negative pole of the diode, a collector end of the transistor couples to the positive pole of the diode, an emitter end of the transistor connects to the ground wire and the output end of the pulse amplifying circuit connects to the collector end of the transistor.

6. The two-wire direct current electric fan system with countable rotation rate of claim 1, wherein the counting circuit is a LM87 counter of the motherboard.

7. The two-wire direct current electric fan system with countable rotation rate of cliam 1, wherein the counter calculates the amplified pulse as the periodic number.
